(19) United States
(12) Patent Application Publication
(10) Pub. No.: US 2005/0063181 A1
(43) Pub. Date: Mar. 24, 2005

(54) LED lamp module and method for manufacturing the same

(75) Inventors: Shingo Chiba, Shizuoka (JP); Haruyuki Matsushita, Shizuoka (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: YAZAKI CORPORATION

(21) Appl. No.: 10/920,403

(22) Filed: Aug. 18, 2004

(30) Foreign Application Priority Data
Sep. 19, 2003 (JP) 2003-328123

(51) Int. Cl. H01R 33/00

(52) U.S. Cl. 362/226

(57) ABSTRACT

Providing an LED lamp module and a method of manufacturing the module preventing deformation and having more freedom for disposing the module, an LED chip for light source, lead terminals having electric-wire pressure contact to be connected with electric wires 39 and supplying source current to the LED chip, an LED lamp 15 including a resin lens 20 sealing the LED chip, and a lamp holder 23 holding the LED chip 15 are molded integrally. Preferably, the resin lens 20 and the lamp holder 23 are molded with different synthetic resin materials by double molding. A connector to be connected with a mating connector is formed at the lamp holder and tab-like terminals continued to the lead terminals project into the connector.

The priority application Number Japan Patent Application Laid Open 2003-328123 upon which this patent application is based is hereby incorporated by reference.

### BACKGROUND OF THE INVENTION

1. Field of the Invention

This invention relates to an LED lamp module used for illuminating an inside of a car cabin, a glove compartment, such as a console box, a glove box, a pocket and an ashtray, a cup holder, a foot area as a light source of an internal light, and used for a stop lamp and a tail lamp as a light source of an external light, and a method of manufacturing the LED lamp module.

2. Description of the Related Art

An LED (Light Emitting Diode) has at least two lead terminals at plus side and minus side. The LED is a semiconductor emitting light in which current of a few mA flows at a few volts depending on a lighting color by supplying a forward voltage, i.e. positive voltage on the lead terminal at plus side and negative voltage on the lead terminal at minus side. The LED lamp is used not only for a vehicle, but also for wide application, such as a camera, a watch, a computer, a printer and a signal. Specially, instead of a usual electric-light bulb in a vehicle, the LED lamp may be used for restraining rise of electric power consumption by increasing various electric devices to be installed in the vehicle.

If the LED lamp is mounted directly on a flat circuit board by soldering, a illuminating device may be structured by disposing a plurality of LED lamps in a flat surface so that flexibility of disposition of LED lamps is limited. One example of an LED lamp for overcoming the above drawback is shown in FIG. 7 (patent document 1).

In the example by prior art, when a plurality of LED lamps 70 is assembled in a curved lighting device such as a tail lamp of the vehicle, electric wires 83 are connected with lead terminals 72 by pressure contact instead of soldering. A slit 73b is formed in a direction of lengthwise of the lead terminal 72 extending outwardly from the LED lamp 70, and by press-fitting the electric wires 83 supplying source current into the slits 73b, the LED lamp 70 and the electric wires 83 are connected electrically. The lead terminal 72 is formed into U-shape by folding and the slit may be formed on a folded position (not shown).

The LED lamp 70 has a bullet shape resin lens 71 and a pair of lead terminals 72 led outwardly from the resin lens 71. Wide portions 73 of the pair of lead terminals 72 are electric-wire pressure contact portions having the slits 73b for connecting with the electric wire. A narrow portion 74 at topside of one lead terminal 72 of the pair of lead terminals is fixed with a LED chip 80. A narrow portion 74 at a topside of the other lead terminal 72 is connected by bonding with a wire 81 joined with the LED chip 80. The resin lens 71 seals the narrow portions 74 at the topsides of the pair of lead terminals 72.

The slit 73b is a U-shape cutout and a taper-shape blade 73a is formed at open-end thereof. A deep side is formed narrower than the open-end. When the electric wire 83 is pushed into the slit 73b, the taper-shape blade 73a tears a cover of the electric wire and the electric wire 83 is pushed into the deep side so as to clamp a core wire thereof and connect electrically.

A projection 73c is formed to protrude in a direction of widthwise from a bottom side of the wide portion 73 of each lead terminal 72. By engaging the projection 73c with a projection 76a of a lamp holder 76, the LED lamp 70 is locked with the lamp holder 76 so that the LED lamp 70 is not removed easily.

The lamp holder 76 is formed into rectangular tube so as to insert the wide portion 73 of each lead terminal 72. Front and rear walls 77 opposite to each other are formed with a slit 79 cut out downwardly from an open end for inserting the electric wire therein. The electric wire 83 abuts on a bottom end of the slit 79 to be positioned in a vertical direction. The lead terminal 72 of the LED lamp 70 is inserted from the open side of the lamp holder 76, and by pushing the LED lamp 70 downwardly, the electric wire 83 is press-fit into the slit 73b of the lead terminal 72.

The patent document 1 is Japan Patent Application Laid Open H11-121807.

Objects to be Solved

The above usual LED lamp 70 has following drawback to be solved. The lead terminal 72 of the LED lamp 70 is formed with the wide portion 73 having the slit 73b for connecting the electric wire 83 with the lead terminal 72 without soldering. However, the narrow portion 74 is formed continuos to the wide portion 73 so that the narrow portion 74 may be buckled and bent when the electric wire 83 is pushed for connecting. A pushing force acts along the lead terminal 72 directly on the resin lens 71 so that the resin lens 71 may be broken or the wire 81 connecting the LED chip 80 with the lead terminal 72 may be open.

The wide portion 73 of the lead terminal 72 is inserted into the lamp holder 76 to be protected from outside. However, the open end of the lamp holder 76 is opened so that when a strong pulling force is acted on the LED lamp 70 or on the lamp holder 76, the LED lamp and the lamp holder may be unlocked and separated. When pulling force acts on the electric wire 83, the electric wire 83 may be moved unexpectedly.

The LED lamp 70 is connected with the electric wire 83 by pressure contact so that manufacturability for connecting is much improved against by soldering. However, when the LED lamp is used for a tail lamp of a vehicle instead of a usual electric light bulb, at least five LED lamps 70 are required. Therefore, a connecting method with further better manufacturability is expected.

The LED lamp 70 and the lamp holder 76 are molded in separated parts, so that tolerance to each others has to be considered and control of dimensions of products is required. If manufactures for the LED lamp 70 and the lamp holder 76 are different, manufacturing cost of the LED lamp module may be increased. If the LED lamp 70 and the lamp holder 76 have no standard specification and different mounting specification, they have no compatibility and cannot be common parts.

To overcome the above drawback, one object of this invention is to provide an LED lamp module which can improve manufacturability of connecting electric wire and assembling, and can prevent deformation of a lead terminal and breakage of a resin lens, and can enhance flexibility of arrangement without limitation of mounting position, and a method of manufacturing the LED lamp module.

How to Attain the Object

In order to attain the objects, an LED lamp module according to this invention is specified by molding an LED lamp and a Lamp holder integrally, the LED lamp having an LED chip for a light source, a plurality of lead terminals being connected with the LED chip and a resin lens sealing the. LED chip; and the lamp holder for holding the LED lamp.

According to above structure, the LED lamp and the lamp holder are integrated to one piece by molding so that process of molding is decreased and number of parts is decreased. By molding the lead terminal and the lamp holder integrally, the lead terminal is supported integrally on a wall of the lamp holder.

The LED lamp module according to this invention is further specified in the aforesaid LED lamp module by that the lead terminal is provided with a pressure contact portion having a U-shaped slit, to be connected with the electric wires.

According to above structure, soldering of the lead terminal and the electric wire is not required, and the lead terminal and the electric wire can be connected easily. Further, the lamp holder supports the lead terminal, so that an inclination and deformation of the pressure contact portion when the electric wire is connected by pressure contact.

The LED lamp module according to this invention is further specified in the aforesaid LED lamp module by that the lamp holder includes a base and a cover to press the electric wires, the cover being removably coupled to the base.

According to above structure, the cover protects a connecting area of the lead terminal and the electric wire, and the electric wire is prevented from moving.

The LED lamp module according to this invention is further specified in the aforesaid LED lamp module by that the lamp holder is provided with a connector to be connected with a mating connector at a power supply side, and the connector is provided with an electric contact portion continued to the lead terminal.

According to above structure, the connector of the lamp holder is connected with the mating connector at the power supply side and the LED lamp and the electric wire are connected electrically through the mating connector by single action. When number of the LED lamps is large, connection by connector is effective to improve manufacturability of connecting the LED lamps with the electric wires.

The LED lamp module according to this invention is further specified in the aforesaid LED lamp module by that the lamp holder and the resin lens are made of two different colors of synthetic resigns.

According to above structure, the resin lens can be molded with epoxy resin advantageous on light transmissivity, moldability and dimensional stability, and the lamp holder can be molded with one of poly butylene terephthalate (PBT) and polypropylene (PP) advantageous on heat resistance, moldability, insulation performance and strength. Thereby, the LED lamp module with the resin lens and lamp holder meeting respective performances can be provided.

A method of manufacturing the LED lamp module according to this invention is specified in the aforesaid LED lamp module by having the steps of forming the lead terminal by punching an electrical conductive plate in accordance with a predetermined circuit pattern and by bending the plate as occasion demands, assembling a bus bar circuit by bonding the LED chip to the lead terminal, producing the LED lamp by molding the resin lens so as to seal the LED chip, and molding the lamp holder for holding the LED lamp by inserting the LED lamp between upper and lower dies.

According to above method, the bus bar circuit is assembled with the LED chip and the lead terminal, and the resin lens is molded on the LED chip, and the LED lamp and the lamp holder are molded integrally.

A method of manufacturing the LED lamp module according to this invention is specified in the aforesaid LED lamp module by having the steps of forming the lead terminal by punching an electrical conductive plate in accordance with a predetermined circuit pattern and by bending the plate as occasion demands, assembling a bus bar circuit by bonding the LED chip to the lead terminal, inserting the bus bar circuit between upper and lower dies, and molding the resin lens for sealing the LED chip and the lamp holder for holding the resin lens simultaneously.

According to above method, the bus bar circuit is assembled with the LED chip and the lead terminal, and the resin lens is molded on the LED chip, and the resin lens sealing the LED chip and the lamp holder having the bus bar circuit inside thereof are molded simultaneously.

The above and other objects and features of this invention will become more apparent from the following description taken in conjunction with the accompanying drawings.

### BRIEF DESCRIPTION OF THE DRAWINGS

FIG. 1 is a perspective view of the first embodiment of an LED lamp module according to this invention;

FIG. 2 is a perspective view showing a lead terminal of an LED lamp shown in FIG. 1;

FIG. 3 is a perspective view showing resin lenses of the LED lamp formed by molding shown in FIG. 1;

FIG. 4 is a perspective view of the LED lamp and a lamp holder integrated in one part by molding shown in FIG. 3;

FIG. 5 is a perspective view of a completed LED lamp module as one part by a punching jig;

FIG. 6 is a perspective view of the second embodiment of an LED lamp module according to this invention; and

FIG. 7 is a perspective view of an LED lamp assembly by prior art.

### DESCRIPTION OF THE PREFERRED EMBODIMENT

An embodiment of an LED lamp module according to this invention is explained as following with reference with drawings.

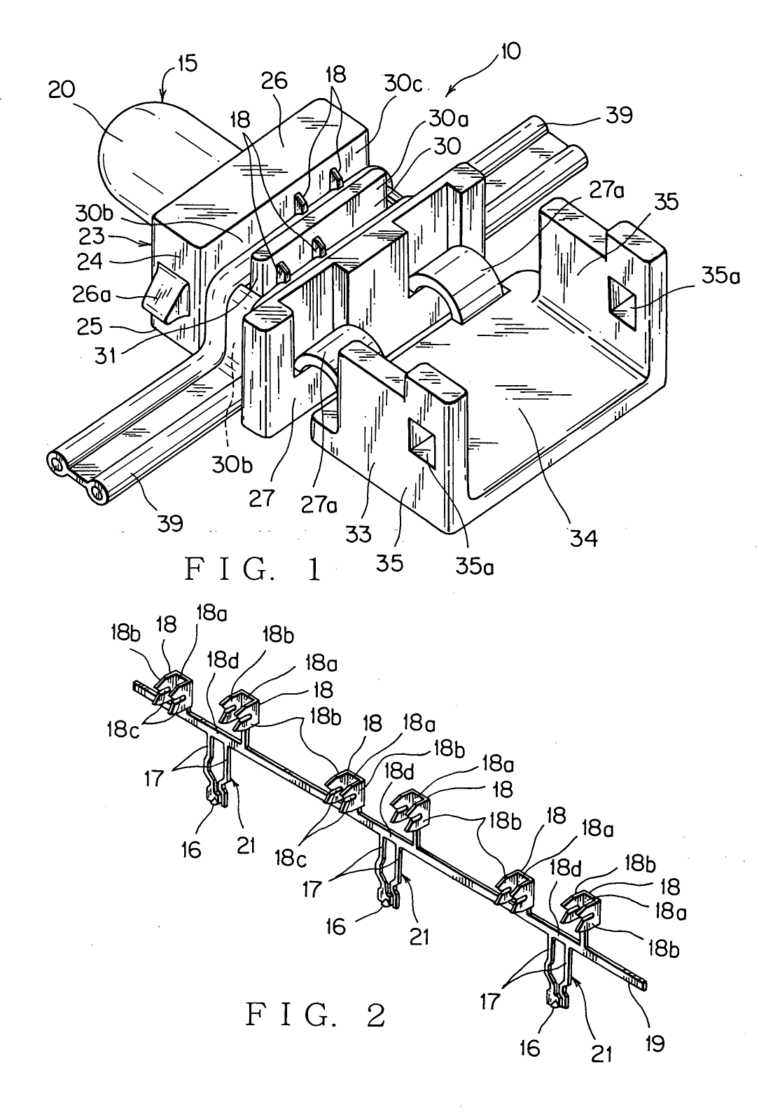

FIG. 1 shows the first embodiment of the LED lamp module according to this invention. FIG. 2-5 shows a method of manufacturing the LED lamp module shown in FIG. 1. FIG. 6 shows the second embodiment of the LED lamp module according to this invention.

LED lamp modules 10, 40 are provided with LED lamps 15, 41 having LED chip 16 as a light source and lamp holders 23, 44 holding the LED lamps 15, 41. The LED lamp modules 10, 40 have features of lower electric power consumption, longer life and higher reliability comparing with a usual electric light bulb. These LED lamp modules 10, 40 can be applied widely for a vehicle or electric products. The embodiment of the LED lamp modules 10, 40 are suitably applied as light sources for illuminating insides of small compartments, such as a console box, a glove box, a pocket for small articles and an ashtray in a vehicle. The LED lamp modules 10 can be used by joining together and applied for a courtesy lamp of the vehicle.

The LED lamp module 10 of the first embodiment can connect the lead terminal 17 and the electric wire 39 without soldering so that manufacturability of connecting is improved. 10 Deformation such as the inclination of an electric-wire pressure contact portion 18 and breakage of a resin lens 20 can be prevented, and the LED lamp module 10 can be disposed freely without limitation of mounting position thereof. An LED lamp 15 include an LED chip 16, a plurality of lead terminals 17 having the electric wire pressure contact portion 18 to be connected with an outer electric wire 39 and supplying source current to the LED chip 16, and a resin lens 20 sealing the LED chip 16. The LED lamp 15 and a lamp holder 23 holding the LED lamp 15 are molded integrally as the LED lamp module 10. Preferably, the resin lens 20 and the lamp holder 23 are molded with two different colors of synthetic resins. The LED lamp module 10 has the aforesaid first features. The lamp holder 23 can be also structured by a base 24 and a cover 33.

In the LED lamp module 40 of the second embodiment, by connecting the lamp holder 44 with a not-shown mating connector at power supply side, the LED lamp 41 and an electric wire 39 can be connected electrically by one action. The LED lamp module has the second features that a connector 46a connecting with a mating connector is formed at the lamp holder 44 and a tab-shape electric contact portion 43a continued to the lead terminal 43 projects into the connector 46a.

Main components and their actions of the LED lamp module 10 as the first embodiment are described hereafter. The LED lamp module 10 includes the LED lamp 15 and the lamp holder 23 holding the LED lamp 15.

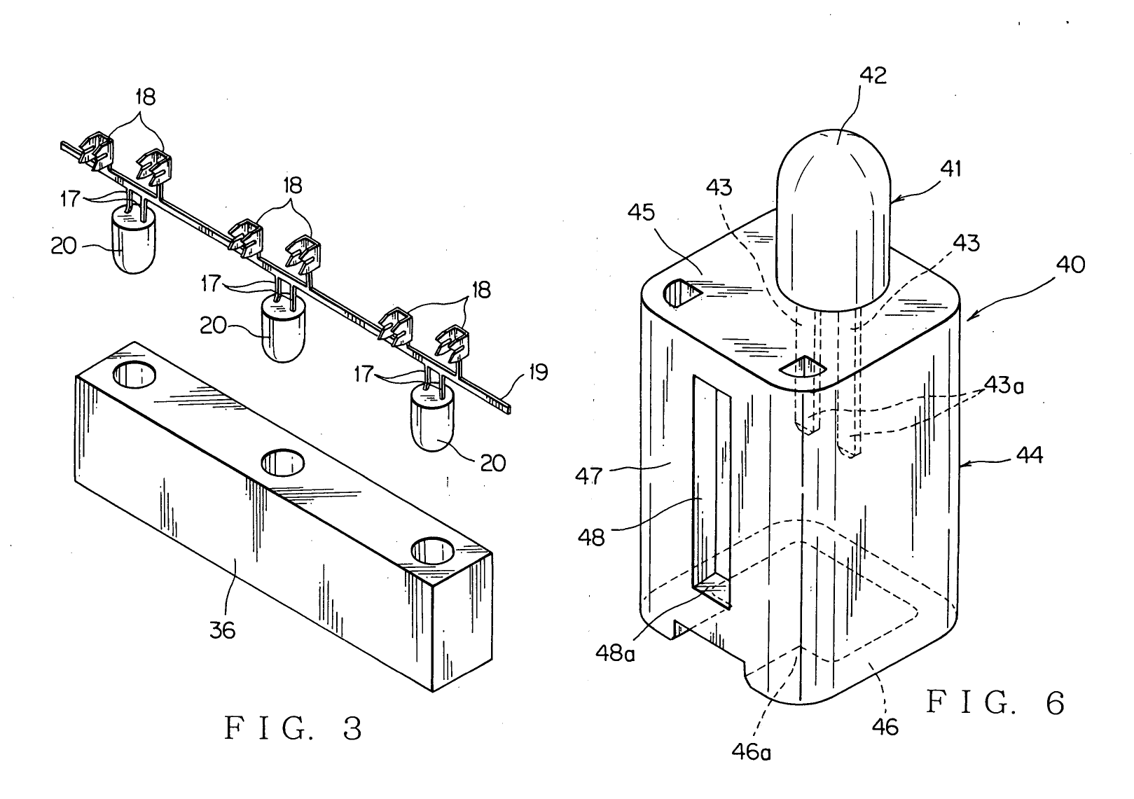

The LED lamp 15 is structured with the LED chip 16 for a light source, a pair of lead terminal 17 and the resin lens 20 sealing the LED chip 16 (FIG. 3). The LED chip 16 is a semiconductor emitting light with a reduced voltage by a not-shown current-limit resistor or a not-shown current regulative diode. Battery voltage of 12 V is reduced to 1.7-5.5 V by a current limit resistor of 300-500 ohms to flow current of a few mA in the LED chip 16.

The lead terminal 17 is punched through an electrical conductive plate in accordance with a predetermined circuit pattern and bent if required. The pair of lead terminal 17 are formed asymmetrically by bending to have a distance to each other at a side near to the pressure contact portion 18 and be close to each other at a side of the LED chip 16. The lead terminals 17 except the pressure contact portion 18 are molded in the later-described lamp holder 23. Therefore, the pair of lead terminals 17 joined by a linking band 19 is separated by cutting a connecting portion 18d connecting each lead terminal 17 after molding the lamp holder.

The LED chip 16 is fixed on one lead terminal 17 of the pair of lead terminals 17 by an electrically conductive adhesive. A not-shown wire led from the LED chip 16 is bonded to the other lead terminal 17 of the pair. The plus-side lead terminal 17, on which the LED chip 16 is fixed, is supplied with source current through a current-limit resistor or a current regulative diode. The minus-side lead terminal 17 performs as a ground terminal. The plus-side lead terminal 17 and the minus-side lead terminal 17 form a bus bar circuit 21.

The electric wire pressure contact portion 18 to be connected with the external electric wire 39 is formed at a position extending from the other end of the each lead terminal 17. The electric wire pressure contact portion 18 is formed into U-shape and provided with a wide base plate 18a continued to the narrow lead terminal 17, and bend portions 18b bent perpendicular to the base plate 18a in the same direction from both sides of the base plate 18a. The electric wire pressure contact portion 18 is exposed from the lamp holder. Each bend portion 18b is formed with a U-shaped slit 18c for press-fitting the electric wire therein. A tapered pressure contact blade is provided at an open end of the slit 18c. The pressure contact blade tears a cover of the press-fitted electric wire 39, and a core wire is exposed. The electric wire 39 is pushed into a deep side of the slit 18c and clamped.

Respective electric wire pressure contact portions 18 of the each lead terminals 17 are formed alternately to each other. The electric wire pressure contact portions 18 are formed to have a different distance from the linking band 19, and the plus-side electric wire 39 and the minus-side electric sire 39 are disposed in parallel to the linking band 19 so as to be contacted by pressure without interference. Pressure contact of the electric wire 39 is acted with a press-fitting jig, and compared with soldering, manufacturability of connecting the electric wire 39 is extremely improved.

The electric wire pressure contact portion 18 is enforced by a wall of the lamp holder 23 (FIG. 1). Thereby, the thin bend portion 18b is not deformed to incline in a direction of thickness thereof by the pressure contact force at connecting the electric wire and prevented from contact failure. The slit 18c may not be expanded so that the electric wire 39 is not moved out of the slit 18c after pressure contact, and reliability of connection is maintained.

The resin lens is molded into bullet shape with epoxy resin advantageous on light transmissivity, moldability and dimensional stability. The epoxy resin is a fragile and hard material. The pressure contact force at connecting the electric wire by pressure may not act directly on the resin lens 20, so that the resin lens 20 is prevented from breakage. The resin lens 20 seals the LED chip 16 and increases an area of emitting light, so that surroundings are illuminated brighter. The resin lens 20 can be molded with not only crystal clear resin but also colored clear resin.

The lamp holder is molded integrally with one of poly butylene terephthalate (PBT) and polypropylene (PP) to have a base 24 and a cover 33 continued to the base 24 through a hinge 27a. The lamp holder 23 is molded with a resin different from that of the resin lens 20 so as to maintain performance of the lamp holder 23 with enough heat resistance, moldability, insulation performance and strength.

The base 24 includes a bottom plate 25, a front wall 26 standing from a front end of the bottom wall 25, and a rear wall 27 opposing to the front wall 26. The resin lens 20 is formed projecting forwardly and integrally with the front wall 26. Right-and-left side walls of the front wall 26 are provided with a projecting lock hook 26a engaging with a lock hole 35a of the cover 33. The rear wall 27 is joined to a pair of hinges 27a for connecting the base 24 and the cover 33. An electric-wire passageway 30 for passing the electric wire 30 therethrough and a partition wall 31 are formed between the front wall 26 and the rear wall 27. Respective electric-wire pressure contact portions 18 connected with a plus-side electric wire 39 and a minus-side electric wire 39 expose in both grooves 30a at both sides partitioned by the partition wall 31. Electric-wire pressure contact portions 18 are respectively disposed in the grooves 30a at both sides of the partition wall 31 so that the electric wires 39 are securely isolated.

Each electric wire 39 is connected at an intermediate area thereof with the electric-wire pressure contact portions 18 so that the electric wire 39 lead out from the base 24 can be connected in parallel with a plurality of LED lamp modules 10. By connecting the plurality of LED lamp modules 10, quantity of light of the LED lamp 15 can be increased to twice or three times.

The cover 33 includes a top wall 34 through the hinge 27a continues to the base 24, and side walls 35 having a lock hole 35a at both sides of the cover 33. By turning the cover 33 180 degrees about the hinge 27a as a rotation supporting point, and by engaging the lock holes 35a with the lock hooks 26a, the cover 33 is locked with the base 24. When the cover 33 locks with the base 24, the top wall 34 covers an opened top of the passageway 30, and a lead-in opening 30b and a lead-out opening 30c of the passageway 30 are covered with the both side walls 35. The electric wire 39 bent step-like at the lead-in opening 30b and the lead-out opening 30c is pushed by bottom edges of the both side walls 36. Thereby, the electric wire 39 is prevented from moving away from the electric-wire pressure contact portion 18 and from moving in a direction of lengthwise, so that reliability of connection by pressure contact can be maintained.

A method of manufacturing the LED module is described with reference to FIG. 2-5. As shown in FIG. 2, by punching and bending an electrically conductive plate according to a circuit pattern, the lead terminals 17 linked by the linking band 19 are formed. In process of forming a lens shown in FIG. 3, by molding the resin lens 20 so as to seal the LED chip 26 of the lead terminal 17, the LED lamp 15 is completed. Molding die 36 shown in FIG. 3 can mold three resin lenses 20. By using elongated molding die, four or more resin lenses 20 can be molded at once.

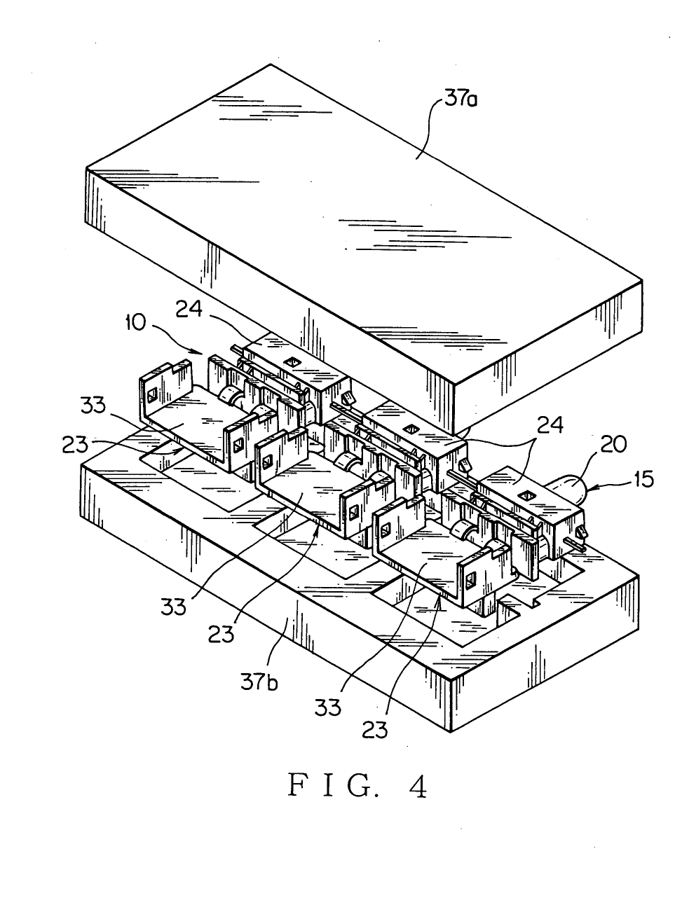

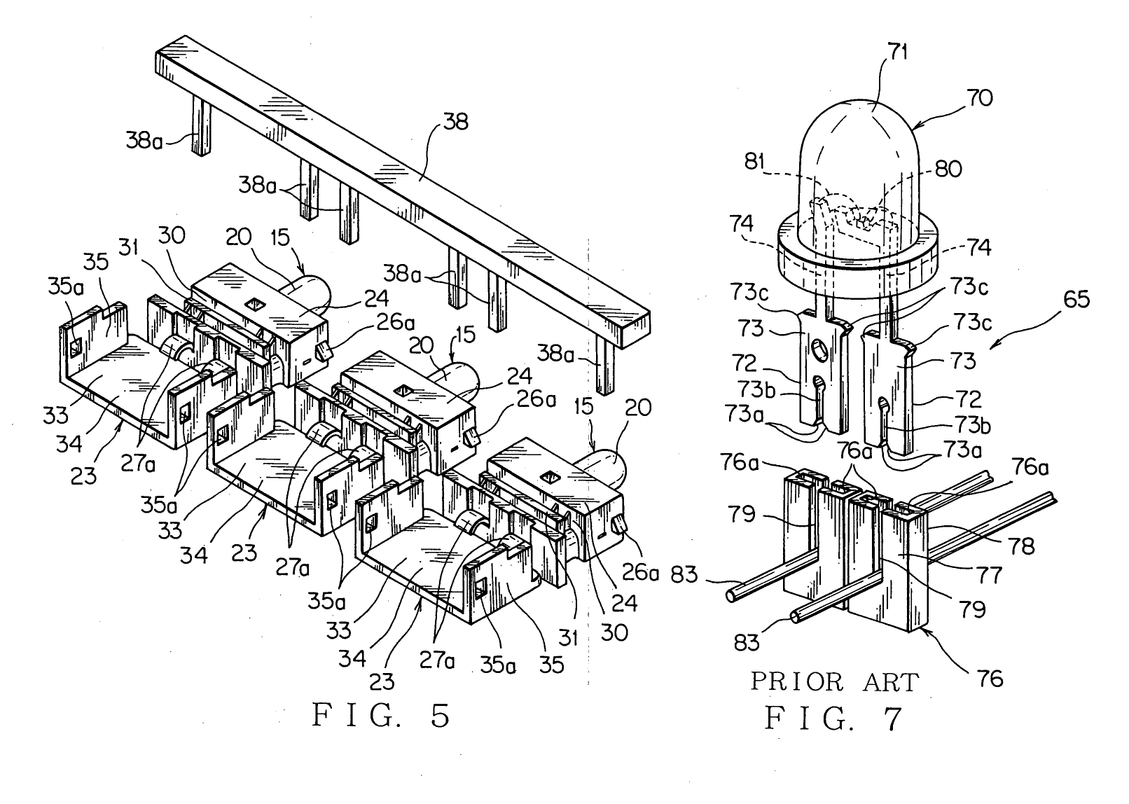

In process of forming a holder shown in FIG. 4, by disposing the LED lamp 15 between a top die 37a and a bottom die 37b, the base 24 and the cover 33 are molded integrally and the lead terminals 17 are molded in the base 24. According to the above processes, the resin lens 20 and the lamp holder 23 can be made of different materials, so that the LED lamp module 10 which satisfies respective performances of the resin lens 20 and the lamp holder 23 can be provided. In process of punching shown in FIG. 5, by separating the linking band 19 by a punching jig 38 with a comb-shaped portion 38a, the LED lamp module 10 is completed as one element.

According to the first embodiment, by molding process, the LED lamp 15 and the lamp holder 23 are integrated to one piece. Thereby, the lead terminal 17 is prevented from deformation such as the inclination and buckling when connecting an electric wire by pressure contact, and reliability of electrical connection is improved. Number of process steps and number of parts can be decreased. Thereby, manufacturability of assembling is enhanced and cost of the LED lamp 15 is reduced. Soldering the lead terminal 17 and the electric wire 39 is eliminated so that the lead terminal 17 and the electric wire 39 can be connected easily.

The second embodiment of the LED lamp module according to this invention will be described herein. The LED lamp module 40 according to the second embodiment is connected with a not-shown mating connector of a power supply side, differing from the LED lamp module 10 according to the first embodiment.

A pair of lead terminals 43 of an LED lamp 41 is formed with a male tab-shape electrical contact 43a to connect with a female terminal of the mating connector. The lead terminal 43 except a part of the electrical contact 43a is molded integrally in a lamp holder 44. The structure and manufacturing method of the other area of the LED lamp 41 are the same as those of the first embodiment, so that description about them is omitted.

The lamp holder 44 is formed into rectangular box-shape with front and rear walls 45, 46 and side wall 47 as outer walls. A resin lens 42 is formed with transparent epoxy resin integrally in the front wall 45. An open-shape fitting portion 46a of a female connector to fit a mating male connector is formed at the rear wall 46. The lead terminal 43 of the LED lamp 41 projects at a deep side of a fitting section. A part of side wall 47 is provided with a slit 48 communicating to the fitting section and extending along fitting direction of the connector. A lock arm (not shown) of the mating connector goes into the slit 48, and by engaging a projection disposed on the lock arm with a lock portion 48a of the slit 48, the mating connector is locked with the lamp holder 44. The structure and manufacturing method of the other area of the lamp holder 44 are the same as those of the first embodiment, so that description about them is omitted.

According to the second embodiment, the lamp holder 44 is connected with the mating connector, so that the LED lamp 41 and the electric wire 39 is electrically connected through the mating connector by one action and efficiency of connecting with electric wires is improved. By connecting with terminals to each other, reliability of connecting is enhanced. The LED lamp module 40 can be mounted freely on any mounting positions.

Not limited above embodiments, this invention can be modified as following:
(1) Regarding the method of manufacturing the LED lamps 15, 41, by combining the processes of forming a lens and forming a holder as one process, the resin lens and lamp holder can be molded at once. Thereby, cost of parts and assembling can be more reduced. Molding at once is acted by an injection molding machine specialized for double injection mold with a set of two injection machines.

This invention further includes following feature not described in the aspect.
(1) It is specified that the partition wall 31 is disposed in the electric wire passageway 30 of the base 24, and the electric-wire pressure contact portions 18 formed extending from the each lead terminal 17 are positioned in the groove 30a at both sides of the passageway 30 partitioned by the partition wall 31. According to the structure, deformation such as an inclination and buckling of the lead terminal 17 can be prevented and manufacturability of connecting the electric wire with the lead terminal can be improved, and short of the pair of the electric-wire pressure contact portions 18 can be securely prevented.

It is further understood by those skilled in the art that the foregoing description is a preferred embodiment of the disclosed device and that various changes and modifications may be made in the invention without departing from the spirit and scope thereof.

1. An LED lamp module comprising:
an LED lamp having an LED chip for a light source, a plurality of lead terminals being connected with the LED chip and a resin lens sealing the LED chip; and
a lamp holder for holding the LED lamp,
whereby the LED lamp and the Lamp holder are molded integrally.

2. The LED lamp module according to claim 1, wherein the lead terminal is provided with a pressure contact portion having a U-shaped slit, to be connected with electric wires.

3. The LED lamp module according to claim 1 or 2, wherein the lamp holder includes a base and a cover to press the electric wires, wherein the cover is removably coupled to the base.

4. The LED lamp module according to claim 1, wherein the lamp holder is provided with a connector to be connected with a mating connector at a power supply side, and the connector has an electric contact continued to the lead terminal.

5. The LED lamp module according to claim 1, 2, 3 or 4, wherein the lamp holder and the resin lens are made of two different colors of synthetic resigns.

6. A method of manufacturing the LED lamp module, according to any one of claims 1-5, comprising the steps of:
forming the lead terminal by punching an electrical conductive plate in accordance with a predetermined circuit pattern and by bending the plate if required;
assembling a bus bar circuit by bonding the LED chip to the lead terminal;
molding the resin lens so as to seal the LED chip to form the LED lamp; and
molding the lamp holder to hold the LED lamp by inserting the LED lamp between upper and lower dies.

7. A method of manufacturing the LED lamp module, according to any one of claims 1-5, comprising the steps of:
forming the lead terminal by punching an electrical conductive plate in accordance with a predetermined circuit pattern and by bending the plate if required;
assembling a bus bar circuit by bonding the LED chip to the lead terminal;
inserting the bus bar circuit between upper and lower dies; and
molding the resin lens for sealing the LED chip and the lamp holder for holding the resin lens simultaneously.
